(19) United States
(12) Patent Application Publication
(10) Pub. No.: US 2006/0284044 A1
(43) Pub. Date: Dec. 21, 2006

(54) Vehicle seat attachment

(76) Inventors: Jennifer P. Lawall, Waterford, MI (US); Steven E. Morris, Fair Haven, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/153,228

(22) Filed: Jun. 15, 2005

(51) Int. Cl. F16M 13/00

(52) U.S. Cl. 248/424

(57) ABSTRACT

Apparatus for attaching a seat to a vehicle body having a floor panel beneath the seat, a rocker panel outboard the seat and a tunnel inboard the seat. An outboard seat adjuster track has a lower track slideable with an upper track and having a forward end and a rearward end. A rearward outboard mounting bracket is attached to the rocker panel and extends inboard to underlie and attach to the rearward end of the lower track of the outboard seat adjuster track. A longitudinal extending inboard seat adjuster track has a lower track that is slideable with an upper track and having a forward end and a rearward end. A rearward inboard mounting bracket is attached to the tunnel and extends outboard to underlie the rearward end of the lower track of the inboard seat adjuster track and having the rearward end of the lower track attached thereto.

### FIELD OF THE INVENTION

The present invention relates to the attachment of vehicle seats, and particularly to a new and improved attachment bracket for attaching the seats to the vehicle body.

### BACKGROUND OF THE INVENTION

It is known for motor vehicles to have a driver seat and a passenger seat that are mounted side by side by and attached to the floor of the vehicle body. Each seat has a seat adjuster mechanism including an inboard seat adjuster track and an outboard seat adjuster track, each having an upper track and a lower track that are slideably interconnected. The lower tracks have legs that reach down and attach to the vehicle floor. The upper track attaches to the seat bottom. A locking mechanism normally locks the upper and lower tracks together, but can be released to permit fore and aft adjusting movement of the seat.

### SUMMARY OF THE INVENTION

The present invention provides a new and improved seat attachment apparatus for a vehicle body having a floor panel beneath the seat, a rocker panel outboard the seat and a tunnel inboard the seat. A longitudinally extending outboard seat adjuster track has an upper track attached to the seat and a lower track that is slideably interconnected with the upper track and has a forward end and a rearward end. A rearward outboard mounting bracket is attached to the rocker panel and extends inboard to underlie the rearward end of the lower track of the outboard seat adjuster track and has the rearward end of the lower track attached thereto. A longitudinal extending inboard seat adjuster track has an upper track attached to the seat and a lower track that is slideably interconnected with the upper track and has a forward end and a rearward end. A rearward inboard mounting bracket is attached to the tunnel and extends outboard to underlie the rearward end of the lower track of the inboard seat adjuster track and has the rearward end of the lower track attached thereto.

The present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a vehicle body having a floor pan, a central tunnel, and an outboard rocker panel, with apparatus mounting a pair of seat adjusters mounted side by side in the vehicle body;

FIG. 2 is a view similar to FIG. 1 but showing an alternative embodiment of the invention; and

FIG. 3 is a view similar to FIGS. 1 and 2 but showing another alternative embodiment of the invention.

### DETAILED DESCRIPTION OF THE EXEMPLARY EMBODIMENTS

The following description of certain exemplary embodiment(s) is merely exemplary in nature and is in no way intended to limit the invention, its application, or uses.

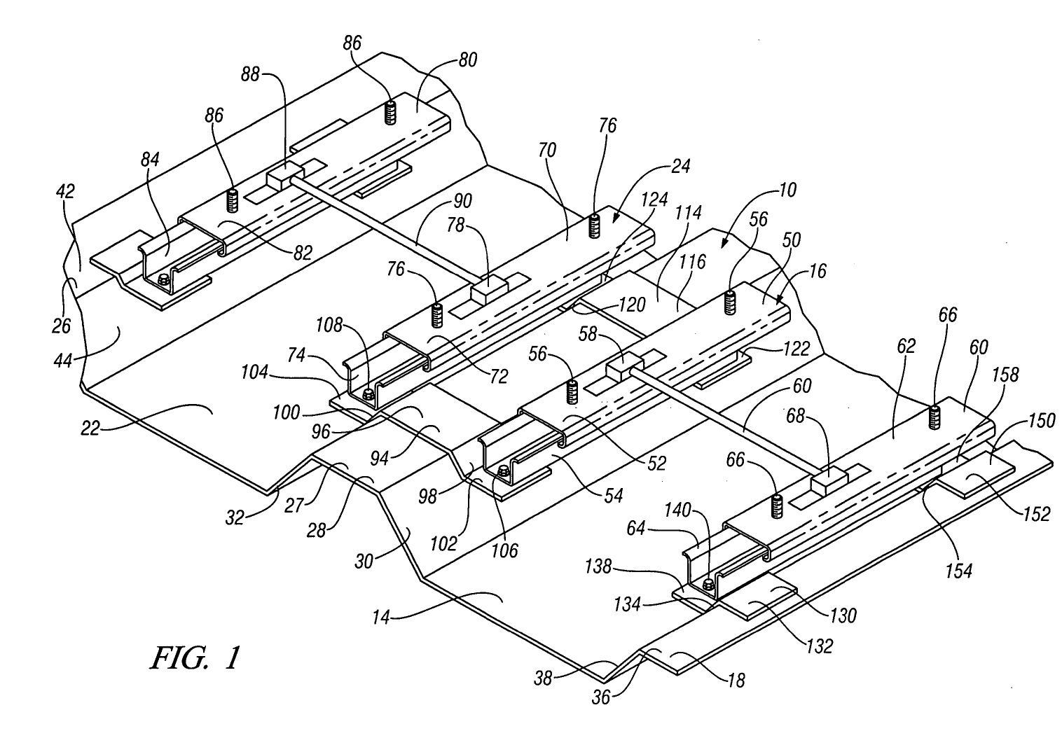

Referring to FIG. 1, it is seen that a conventionally constructed vehicle body 10 includes a floor structure that has a central tunnel 12, a floor pan 14 beneath a passenger seat adjuster 16, a rocker panel 27 outboard the passenger seat adjuster 16, a floor pan 22 beneath a driver seat adjuster 24, and a rocker panel 26 outboard the driver seat adjuster 24.

The floor structure can be a one-piece stamping, or may be assembled from a number of stampings that are welded together. The central tunnel 27 includes a top wall 28 and spaced-apart side walls 30 and 32. The passenger side rocker panel includes a top wall 36 and a side wall 38 that is joined with the floor pan 14. Likewise, the driver side rocker panel 26 includes a top wall 42 and a side wall 44 joined to the floor pan 22 beneath the driver seat adjuster 24.

The passenger side seat adjuster 16 includes an inboard seat adjuster track 50 having an upper track 52 and a lower track 54 that are slideably interconnected. Studs 56 project upwardly forward the upper track 52 to mount a seat bottom, not shown. A locking mechanism 58 acts between the upper track 52 and lower track 54 to lock the upper track 52 and the lower track 54 against sliding movement, and can be released by a release rod 60 to permit fore and aft sliding movement of the upper track 52 relative to the lower track 54. The passenger side seat adjuster 16 also includes an outboard seat adjuster track 60 having an upper track 62, lower track 64, seat mounting studs 66, and a locking mechanism 68 that is connected with the release rod 60.

Referring to FIG. 1, it will be seen and appreciated that the driver side seat adjuster 24 is constructed similarly to the passenger side seat adjuster 16. In particular, an inboard driver side seat adjuster track 70 includes upper track 72, lower track 74, studs 76, and locking mechanism 78. An outboard driver side seat adjuster track 80 includes upper track 82, lower track 84, studs 86, and locking mechanism 88. A lock rod 90 connects the locking mechanisms 78 and 88.

FIG. 1 shows the rearward ends of both the inboard seat adjuster track 50 of the passenger side and the inboard seat adjuster track 70 of the driver side are attached to the tunnel 27 of the vehicle body floor structure 10. In particular, a bracket 94 of an inverted U-shape straddles the tunnel 28 and reaches beneath the rearward ends of the seat adjuster tracks 50 and 70. The bracket includes a top wall 96 that lies on the top wall 28 of the tunnel 27, side walls 98 and 100 that respectively lie on the side walls 30 and 32 of the tunnel 27, and arms 102 and 104 that respectively extend outboard and horizontally from the side walls 30 and 32. The arm 102 extends beneath the lower track 54 of the passenger side seat adjuster track 50 and is attached thereto by a bolt 106. Likewise, the arm 104 extends beneath the lower track 74 of the driver side seat adjuster track 70 and is attached thereto by a bolt 108.

The top wall 96 is welded to the top wall 28 of the tunnel 27. The side walls 98 and 100 of the bracket are welded to the side walls 30 and 32 of the tunnel 27. The side walls 98 and 100 may be relatively shorter or longer, and thereby determine the height of the seat adjuster tracks 50 and 70 above the floor pans 14 and 22.

Thus, it is seen that the bracket 94 is effective to mount the rearward ends of the inboard seat adjuster tracks 50 and 70 to the vehicle body structure 10 in way that supports the rearward end of the seat adjuster tracks substantially above the floor pan 14 and 22, thereby creating and maximizing a space to receive the feet of person that might be seated behind the seat mounted by bracket 94, or to permit the storage of personal items beneath the seat.

FIG. 1 also shows that the forward ends of the inboard seat adjuster tracks 50 and 70 are attached to the tunnel 27 by a U-shaped bracket 114. The bracket 114 is similar to the bracket 94 and includes a top wall 116 that lies on the top wall 28 of the tunnel 27, side walls (not shown) and 120 that respectively lie on the side walls 30 and 32 of the tunnel 27, and arms 122 and 124 that respectively extend outboard and horizontally from the side walls 30 and 32. The arm 122 extends beneath the forward end of lower track 54 of the passenger seat and is attached thereto by a bolt, not shown. Likewise, the arm 124 extends beneath the lower track 74 of the driver side seat adjuster track 70 and is attached thereto by a bolt, not shown.

FIG. 1 also shows that the outboard seat adjuster track 60 of the passenger side seat adjuster 16 is attached to the rocker panel 18. In particular, a rearward bracket 130 has a top wall 132 that lies on the top wall 36 of the rocker panel 18, a side wall 134 that lies on the side wall 38 of the rocker panel 18, and a horizontal arm 138 that reaches inboard and supports and is bolted to the rearward end of the lower track 64 by bolt 140. A forward bracket 150 has a top wall 152 that lies on the top wall 36 of the rocker panel 18, a side wall 154 that lies on the side wall 38 of the rocker panel 18, and a horizontal arm 158 that reaches inboard and supports and is bolted to the forward end of the lower track 64 by a bolt, not shown.

The outboard seat adjuster track 80 of the driver side seat is attached to the rocker panel 26 of the vehicle body by brackets 162 and 164 like the brackets 130 and 150 that attach the passenger side outboard seat adjuster track 60.

Thus, it is seen in FIG. 1 that the seat adjuster mounting apparatus is effective to suspend and support the seat adjuster tracks from the rocker panel and the tunnel in a way that eliminates the necessity for seat adjuster legs that attach to the floor. The seat adjuster mounting mechanism leaves unobstructed space beneath the seat for storage or the placement of occupant feet. The unobstructed space is defined by the floor pan at the bottom, the tunnel at the inboard side, the rocker panel at the outboard side, and by the underside of the lower track at the top.

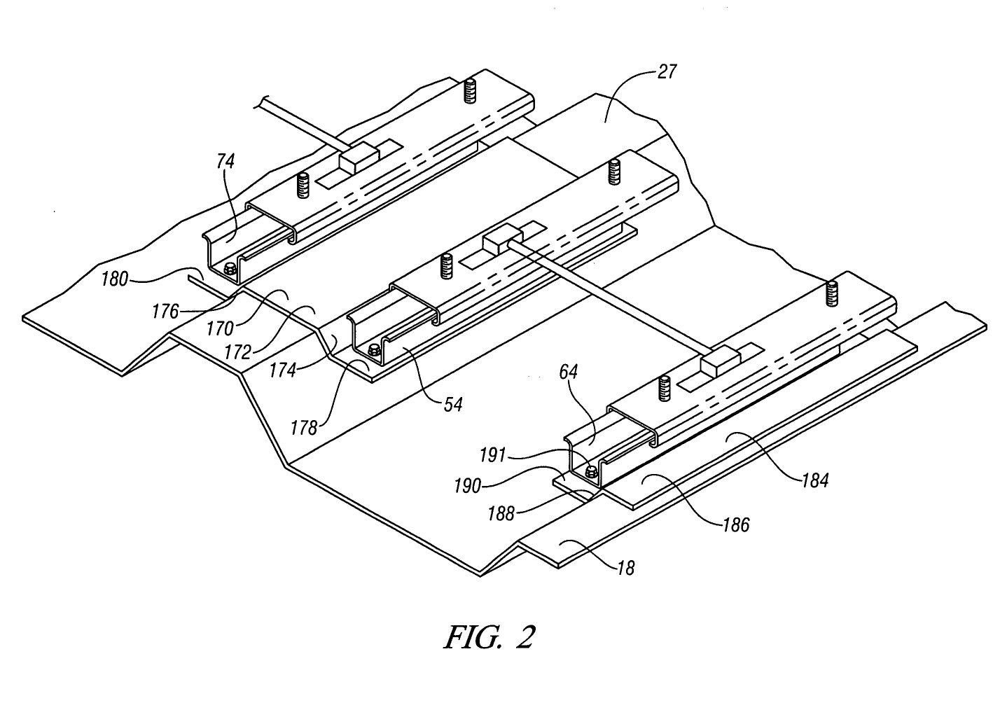

FIG. 2 shows an alternative embodiment of the invention in which it will be seen that tunnel brackets 94 and 114 of the first embodiment have been replaced by a single bracket 170 that is also of an inverted U-shape, with a top wall 172, side walls 174 and 176, and arms 178 and 180 that reach respectively under the lower tracks 54 and 74 and are bolted thereto. -The use of a single bracket 170, that extends longitudinally the entire length of the seat adjuster tracks, simplifies the construction and the single bracket 170 also serves to reinforce the strength of the tunnel 27 and the strength of the lower tracks 54 and 74. FIG. 2 also shows that the outboard brackets 130 and 150 of FIG. 1 have been replaced by a single bracket 184 that extends along the rocker for the entire length of the seat adjuster tracks, is welded to the tunnel, and thereby reinforces the rocker panel 18 and the lower track 64.

It will also be understood that, if desired, the single tunnel bracket 170 of FIG. 2 can be used in conjunction with the two separate rocker brackets 130 and 150 of FIG. 1. Or, the two separate tunnel brackets 94 and 114 of FIG. 1 can be used in conjunction with the single rocker bracket 184 of FIG. 2.

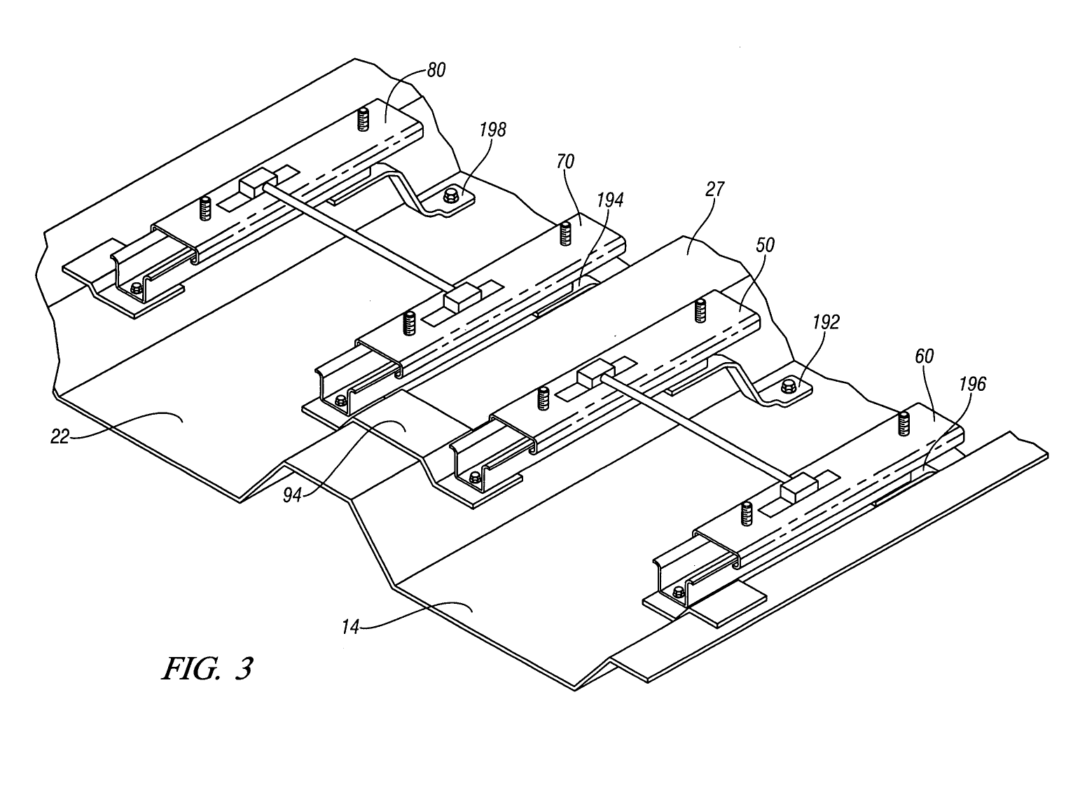

FIG. 3 shows another alternative embodiment of the invention. In FIG. 3, the rearward end of the inboard seat adjuster tracks 50 and 70 are mounted to the tunnel 27 by the same bracket 94 as in FIG. 1. However, the forward ends of the inboard seat adjuster tracks 50 and 70 are mounted to the floor pans 14 and 22 by conventional legs 192 and 194. Likewise, the forward ends of the outboard seat adjuster tracks 60 and 80 are mounted to the floor by conventional legs 196 and 198. Thus, at the rearward end the seat adjuster track is suspended substantially above the floor to create a foot space or storage space, while the forward ends of the seat adjuster tracks are conventionally mounted by legs.

The foregoing description of the invention is merely exemplary in nature and, thus, variations thereof are intended to be within the scope of the invention.

What is claimed is:

1. Apparatus for attaching a vehicle seat to a vehicle body having a floor pan beneath the seat, a rocker panel outboard the seat and a tunnel in board the seat, comprising:
a longitudinal extending outboard seat adjuster track having an upper track attached to the seat and a lower track that is slidalbly interconnected with the upper track and has a forward end and a rearward end;
a rearward outboard mounting bracket attached to the rocker panel and extending inboard to underlie the rearward end of the lower track of the outboard seat adjuster track and having the rearward end of the lower track attached thereto;
a longitudinal extending inboard seat adjuster track having an upper track attached to the seat and a lower track that is slideably interconnected with the upper track and has a forward end and a rearward end;
and a rearward inboard mounting bracket attached to the tunnel and extending outboard to underlie the rearward end of the lower track of the inboard seat adjuster track and having the rearward end of the lower track attached thereto.

2. The apparatus of claim 1 in which the outboard mounting bracket and the inboard mounting bracket respectively extend inboard from the rocker panel and outboard from the tunnel in substantial vertical spaced relation above the vehicle floor pan so as to define a space for the placement of the feet of a vehicle occupant seated behind the vehicle seat.

3. The apparatus of claim 1 in which the forward end of the lower track of one of the outboard and inboard seat adjuster tracks has an integral leg that is attached to the vehicle floor pan.

4. The apparatus of claim 1 in which the lower track of the inboard seat adjuster track has a forward end and a forward inboard mounting bracket is attached to the tunnel and extends outboard to underlie the forward end of the lower track and support the forward end of the lower track substantially above the floor pan.

5. The apparatus of claim 1 in which the lower track of the outboard seat adjuster track has a forward end and a forward outboard mounting bracket is attached to the rocker panel and extends inboard to underlie and support the forward end of the outboard seat adjuster track substantially above the floor pan.

6. The apparatus of claim 4 in which the rearward inboard mounting bracket and the forward inboard mounting bracket are fabricated as a one piece stamping that extends longitudinally along the tunnel between the forward and rearward ends of the lower track.

7. The apparatus of claim 5 in which the rearward outboard mounting bracket and the forward outboard mounting bracket are fabricated as a one piece stamping that extends longitudinally along the rocker panel between the forward and rearward ends of the lower track.

8. The apparatus of claim 1 in which the rear outboard mounting bracket extends longitudinally along the rocker panel to also underlie and be attached to the forward end of the lower track of the outboard seat adjuster track, and the rear inboard mounting bracket extends forward along the tunnel to also underlie and be attached to the forward end of lower track of the inboard seat adjuster track.

9. The apparatus of claim 8 in which the brackets are welded respectively to the rocker panel and the tunnel and respectively reinforce and strengthen the rocker panel and the tunnel.

10. Apparatus for attaching a pair vehicle seats side by side in a vehicle body having a floor pan beneath the each seat, a rocker panel outboard each seat and a tunnel inboard the seats, comprising:
each seat having a longitudinal extending outboard seat adjuster track extending alongside the respective rocker panel and having an upper track attached to the seat and a lower track that is slideably interconnected with the upper track and having a forward end and a rearward end;
each seat having a longitudinal extending inboard seat adjuster track extending alongside the tunnel and having an upper track attached to the seat and a lower track that is slideably interconnected with the upper track and has a forward end and a rearward end;
and an inboard mounting bracket that straddles the tunnel and extends outboard from the tunnel to underlie and support at least the rearward ends of the inboard seat adjuster tracks of the pair of seats substantially above the plane of the floor pan to provide an unobstructed space beneath the seat adjuster tracks.

11. The apparatus of claim 10 in which the inboard mounting bracket is a one piece stamping that overlies and straddles the tunnel and extends sufficiently in the longitudinal direction to mount both the rearward ends and the forward ends of the pair of inboard seat adjuster tracks of the pair of side by side seats.

12. The apparatus of claim 10 in which an outboard mounting bracket is attached to the rocker panel adjacent each of the outboard seat adjuster tracks and extends inboard to underlie and support and have the forward ends of the lower tracks of the respective seat adjusters attached thereto and supported in vertically space relation above the vehicle floor.

13. Apparatus for attaching a vehicle seat above a vehicle floor pan in a vehicle having a longitudinal extending rocker panel outboard the seat and a longitudinal extending tunnel inboard the seat, comprising:
a tunnel bracket that is attached to the tunnel and extends outboard from the tunnel and above the floor pan;
a rocker bracket that is attached to the rocker panel and extends inboard from the rocker and above the floor pan;
and an inboard seat adjuster track having a lower track attached to the tunnel bracket to support the lower track above the floor pan and leave unobstructed storage space defined between the floor pan, the rocker panel, the tunnel and the tunnel and rocker brackets.

14. The apparatus of claim 13 in which the tunnel bracket is of an inverted U-shape that straddles the tunnel and has first and second arms extending outboard therefrom on both sides so as to support the lower track of seat adjuster tracks for a driver seat and a passenger seat that are mounted side by side in the vehicle on opposite sides of the tunnel.

15. The apparatus of claim 14 in which the tunnel bracket has a top wall that rests upon and is welded to a top wall of the tunnel, and side walls that depend part way along side walls of the tunnel and are welded to the tunnel side walls.

16. The apparatus of claim 13 in which the seat includes an outboard seat adjuster track having a lower track attached to the rocker panel bracket to support the lower track above the floor pan and leave unobstructed storage space defined between the floor pan, the rocker panel, the tunnel and the tunnel and rocker brackets.

17. The apparatus of claim 13 in which the rocker bracket has an upper wall that rests upon and is welded to a top wall of the rocker panel, and a side wall that depends part way along a side wall of the rocker panel and is welded to the side wall of the rocker panel.

18. The apparatus of claim 13 in which the lower track of the inboard seat adjuster has forward and rearward ends and the tunnel bracket extends longitudinally along the tunnel to attach to both the forward and the rearward ends of the lower track.

19. The apparatus of claim 18 in which the seat includes an outboard seat adjuster track having a lower track attached to the rocker panel bracket to support the lower track above the floor pan and leave unobstructed storage space defined between the floor pan, the rocker panel, the tunnel and the tunnel and rocker brackets.

20. The apparatus of claim 19 in which the rocker bracket has an upper wall that rests upon and is welded to a top wall of the rocker panel, and a side wall that depends part way along a side wall of the rocker panel and is welded to the side wall of the rocker panel.
